(19) United States
(12) Patent Application Publication
(10) Pub. No.: US 2026/0120402 A1
(43) Pub. Date: Apr. 30, 2026

(54) METHOD AND APPARATUS FOR GENERATING POSE INFORMATION ABOUT A VIRTUAL 3D OBJECT

(71) Applicant: SAMSUNG ELECTRONICS CO., LTD., Suwon-si (KR)

(72) Inventors: Sathish CHALASANI, Bangalore (IN); Abhishek Joshi, Bangalore (IN); Rachit Agarwal, Bangalore (IN); Kiran Nanjunda Iyer, Bangalore (IN); Biplab Ch Das, Bangalore (IN); Praveen C, Bangalore (IN)

(73) Assignee: SAMSUNG ELECTRONICS CO., LTD., Suwon-si (KR)

(21) Appl. No.: 19/432,511

(22) Filed: Dec. 24, 2025

Related U.S. Application Data
(63) Continuation of application No. PCT/KR2024/008904, filed on Jun. 26, 2024.

(30) Foreign Application Priority Data
Jun. 26, 2023 (IN) 202341042857
Jun. 22, 2024 (IN) 202341042857

(51) Int. Cl. G06T 17/00; G06V 10/46; G06V 10/77

(52) U.S. Cl. CPC G06T 17/00; G06V 10/462; G06V 10/7715

(57) ABSTRACT

The disclosure relates to a method and electronic device for generating pose information about a virtual 3D object. The electronic device obtains a feature map based on at least one RGB image frame captured by the electronic device, obtains depth information of an object in the at least one RGB image frame through at least one depth sensor associated with the electronic device, generates a contour mask of the object based on the feature map, generates a 3D point cloud of the object based on the contour mask and the depth information and generates a plurality of pose features of the object for representation in a 3D virtual space based on the contour mask and the 3D point cloud.

### CROSS-REFERENCE TO RELATED APPLICATIONS

This application is a bypass continuation application of International Application No. PCT/KR2024/008904, filed on Jun. 26, 2024, which is based on and claims priority under 35 U.S.C. § 119 to Indian Patent Application No. 202341042857 filed on Jun. 22, 2024, which claims priority to Indian Patent Application No. 202341042857 filed on Jun. 26, 2023, the disclosures of which are incorporated herein by reference in their entireties.

### BACKGROUND

### 1. Field

The disclosure relates to object pose prediction in 3D computer vision, more particularly to a method and apparatus for generating pose information about a virtual 3D object.

### 2. Description of Related Art

Augmented reality (AR) and virtual reality (VR) are fields within three dimensional (3D) computer vision that combine the digital and real worlds. More particularly, augmented reality (AR) aims to enhance real world by inserting 3D virtual objects into the real world environment. In order to accomplish this goal, it is important that virtual objects are rendered and aligned in a real scene in an accurate and visually acceptable way. To render and align virtual objects in the real scene in an accurate and visually acceptable way, estimating a 9-Degree of Freedom (DoF) object pose, e.g., 3D rotation, translation, and absolute size of the objects, is necessary. However, related art techniques in AR and VR fields have a problem when it comes to detecting an object and estimating a 9-DoF object pose for the object.

The related art approaches for object detection in Augmented Reality (AR) do not generalize well for many object categories. The related art approaches in fields like object detection or image segmentation have developed a separate model for each object category. This means that for each type of object that the system needs to recognize, a distinct model is trained and used. Hence, the related art approaches may not be scalable enough for real-world scenarios where the number of object categories can be very large and constantly growing.

Further, the related art 3D datasets for object detection and object pose estimation have some limitations in solving real-world problems. Many related art datasets are designed with certain assumptions that are specific to a particular problem. For instance, some datasets assume a fixed yaw, effectively providing only 8 Degrees of Freedom (8DoF). This makes it challenging to use these datasets for a general object pose-estimation problem, which requires full 9-DoF information. Open-source datasets for real objects with 9-DoF are quite rare and often come with a small number of objects. This scarcity is primarily due to the high complexity involved in data collection and annotation. Moreover, other datasets also come with their own set of limitations. For example, some datasets provide 9-DoF but only with synthetic data. Others might contain 9-DoF with real objects but are limited in number. There are also datasets that do not contain the depth information, which is crucial for certain applications.

Furthermore, there are also several other limitations in the related art 3D datasets. Most of the current open-source and popular 3D datasets are prepared in a controlled environment. This makes it difficult to capture the pose of an object from all viewpoints. Moreover, it's challenging to include all object diversities, e.g., account for intra-class variations. Intra-class variations refer to the differences within the same category of objects. For example, bottles can have thousands of variants with changes in color, textures, size, and orientations. Though there are several data augmentation techniques to tackle this challenge such as creating new data by modifying the related art data in some way, such as rotating, scaling, or changing the color of the images. However, these techniques do not generalize well for all the viewpoints or intra-class variations. For object detection and object pose estimation techniques to generalize well for an object category, it is necessary to understand the geometry of the object semantically. This means understanding the inherent geometric shape of the object category, regardless of the specific variations within the category.

In the field of 3D computer vision, most related art architectures propose to follow either monocular or depth-based methods. Monocular-based methods use RGB information from a single camera. This RGB information provides important visual cues that can help in estimating the pose of an object. However, these methods do not provide information about the absolute scale of the object, which can be crucial in many applications. On the other hand, depth-based methods use depth information to provide the absolute scale of the object. This is particularly desirable for real-world Augmented Reality (AR) use cases, where understanding the real size of the objects is important. Therefore, it is necessary to leverage both RGB and depth modalities to have the best of both worlds-the visual cues from RGB information and the absolute scale from depth information. However, it is very difficult to fuse both these modalities due to strict memory and execution time constraints. These constraints make it challenging to process the large amount of data from both modalities in real-time.

Thus, it is desired to address the above-mentioned disadvantages or other shortcomings or at least provide a useful alternative.

### SUMMARY

According to an aspect of the disclosure, there is provided a method of generating pose information for a virtual three dimensional (3D) object by an electronic device, the method including: obtaining, a feature map based on at least one RGB image frame captured by a camera of the electronic device; obtaining depth information of an object in the at least one RGB image frame through at least one depth sensor associated with the electronic device; generating, a contour mask of the object based on the feature map; generating a 3D point cloud of the object based on the contour mask and the depth information; generating a plurality of pose features of the object for representation in a 3D virtual space based on the contour mask and the 3D point cloud.

According to another aspect of the disclosure, there is provided an electronic device including: a camera; at least one depth sensor; a memory storing one or more instruction; and at least one processor configured to execute the one or more instructions stored in the memory; wherein the one or more instructions, when executed by the at least one processor, is configured to cause the electronic device to: obtain a feature map based on at least one RGB image frame captured by the camera; obtain depth information of an object in the at least one RGB image frame through the at least one depth sensor; generate a contour mask of the object based on the feature map; generate a three dimensional (3D) point cloud of the object based on the he contour mask and the depth information; and generate a plurality of pose features of the object for representation in a 3D virtual space based on the contour mask and the 3D point cloud.

According to another aspect of the disclosure, there is provided a computer-readable recording medium having recorded thereon a program for performing a control method on a computer, the control method including: obtaining, a feature map based on at least one RGB image frame captured by a camera of an electronic device; obtaining depth information of an object in the at least one RGB image frame through at least one depth sensor associated with the electronic device; generating, a contour mask of the object based on the feature map; generating a 3D point cloud of the object based on the contour mask and the depth information; generating a plurality of pose features of the object for representation in a 3D virtual space based on the contour mask and the 3D point cloud.

One or more embodiments of the disclosure is explained by considering an electronic device which may be an AR device (Augmented Reality). However, this is only for the purpose of illustration and explanation and should not be construed as a limitation of the disclosure, as the disclosure is capable of working in any electronic device configured for handling 3D computer vision tasks.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. An embodiment of system and/or methods in accordance with embodiments of the present subject matter are now described, by way of example only, and with reference to the accompanying figures, in which:

FIG. 1A shows an exemplary electronic device for generating a virtual 3D object in accordance with an embodiment of the disclosure;

FIG. 1B shows an exemplary architecture for generating a virtual 3D object in accordance with an embodiment of the disclosure;

FIG. 2A shows a detailed block diagram of the electronic device, in accordance with an embodiment of the disclosure;

FIG. 2B shows an exemplary block diagram of the first prediction module in accordance with an embodiment of the disclosure;

FIG. 2C shows an exemplary block diagram of the second prediction module in accordance with an embodiment of the disclosure;

FIG. 3 shows an exemplary flowchart illustrating a method of generating a virtual 3D object in accordance with an embodiment of the disclosure;

FIG. 4A shows an exemplary block diagram for training the first prediction module to operate in a first prediction mode, in accordance with an embodiment of the disclosure;

FIG. 4B shows an exemplary block diagram for training the second prediction module to operate in a second prediction mode, in accordance with an embodiment of the disclosure.

FIG. 5 shows a training setup for pre-generating the training dataset for the electronic device in accordance with an embodiment of the disclosure;

FIGS. 6A and 6B illustrate an exemplary scenario of using the electronic device for generating a virtual 3D object in accordance with an embodiment of the disclosure; and

FIG. 7 is a block diagram of an exemplary computer system for implementing embodiments consistent with the disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over an embodiment.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the scope of the disclosure.

A ‘model’ and an ‘artificial intelligence (AI) model’ used herein may refer to a model set to perform desired characteristics (or a purpose) by being trained using a plurality of training data by a learning algorithm. Examples of the learning algorithm include, but are not limited to, supervised learning, unsupervised learning, semi-supervised learning, or reinforcement learning.

A ‘model’ and an ‘AI model’ used herein may be composed of a plurality of neural network layers. Each of the plurality of neural network layers may have a plurality of weight values, and may perform a neural network operation through an operation between an operation result of a previous layer and the plurality of weight values. The plurality of weight values of the plurality of neural network layers may be optimized by a learning result of the AI model. For example, the plurality of weight values may be updated so that a loss value or a cost value obtained from the AI model is reduced or minimized during a learning process. Examples of the AI model including a plurality of neural network layers may include, but are not limited to, a deep neural network (DNN), for example, a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), and Deep Q-Networks.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like.

The processor may include various processing circuitry and/or multiple processors. For example, as used herein, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of the described functions and another processor(s) performs other of the described functions, and also situations in which a single processor may perform all the described functions. In an embodiment, the at least one processor may include a combination of processors performing various combination of the described functions, e.g., in a distributed manner. At least one processor may execute program instructions to achieve or perform various functions.

As discussed in the background section, there is a need to provide a method and apparatus for generating a virtual 3D object. In the context of the disclosure, the apparatus may be an electronic device capable of performing the method disclosed in the disclosure. Examples of the electronic device are provided in the further sections of the disclosure. The method includes predicting pose features of one or more objects in an RGB image frame to provide a plurality of pose features ((9 Degrees of Freedom (9-DoF)) of a selected object in in a RGB image frame captured by the electronic device, for example an AR device. In the disclosure, predicting certain data can be interpreted as generating the corresponding data. In other words, in one embodiment, the electronic device can obtain pose features of an object in the RGB image frame. In the context of AR applications, such as overlaying a new texture 3D model of a keyboard onto an actual keyboard, the use of 9-DoF object pose prediction significantly enhances user experience. Without the implementation of 9-DoF, the results could be unsatisfactory. Further, as discussed in the background section, the electronic device should be able to provide a more scalable and flexible object detection and pose prediction approaches that can handle a wide range of object categories without the need for separate models for each one. In an embodiment, there is a need to create more diverse and representative datasets.

In the disclosure, the terms ‘extract’ and ‘capture’ may be replaced with or interpreted as ‘obtain’. For example, the operation of the electronic device extracting a feature map or capturing depth information may be interpreted as obtaining the feature map or obtaining the depth information.

In the disclosure, the term “selected object” may refer to an object chosen from a plurality of candidate objects included in an RGB image frame based on user input. In one embodiment, the electronic device may display a list of candidate objects in the RGB image frame and obtain user input selecting one of the displayed candidate objects. Based on this user input, the electronic device may determine the selected object for which pose features are to be predicted. However, the selected object is not limited to this example and may refer to any object chosen based on specific criteria. For convenience in the following description, the term “selected object” is used to refer to an object chosen from one or more objects included in the RGB image frame.

In an embodiment, as discussed in the background section, there is a need to efficiently combine methods that can effectively combine a first prediction mode which may be also referred as monocular method (method based on RGB information) and a second prediction mode which may be also be referred as a depth-based method (method based on depth information) while meeting the stringent requirements of the AR devices. The electronic device such as the AR device should be able to process any captured image from a real-world scene and should be able to overlay digital information (like 3D models, text, or animations) onto a user's view of the real world scene accurately in accordance with pose features (degrees of freedom) of the objects in the real world scene.

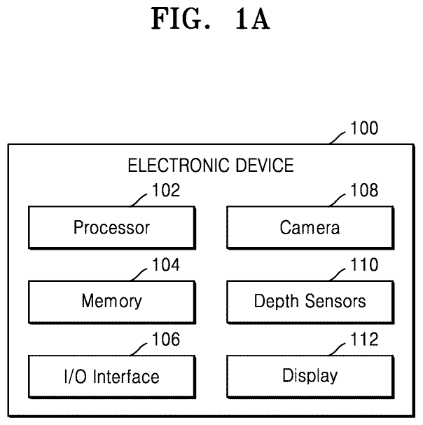

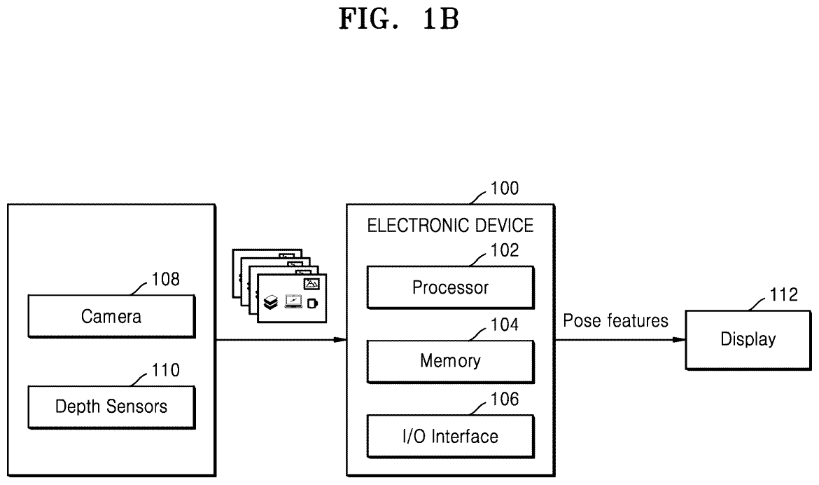

FIG. 1A shows an exemplary electronic device 100 for generating a virtual 3D object. The electronic device 100 may capture at least one RGB image frame of a real-world scene including one or more objects from the real-world scene. The electronic device 100, according to embodiments of the disclosure, may include an Augmented Reality (AR) device, Virtual Reality (VR) device, a laptop, a palmtop, a desktop, a mobile phone, a smart phone, Personal Digital Assistant (PDA), a tablet, a wearable device, an Internet of Things (IoT) device, a foldable device, a flexible device, a display device, an immersive system, portable game consoles, cameras, and wearable devices, among others. In an embodiment, the electronic device may be one or a combination of the above-listed devices. In an embodiment, the electronic device 100 as disclosed herein is not limited to the above-listed devices and can include new electronic devices depending on the development of technology, that are capable of being configured with the method disclosed in the disclosure.

In an embodiment, the electronic device 100 may include a processor 102, a memory 104 and an Input/Output (I/O) interface 106. The processor 102 may include one or more processors or other processing devices and execute the OS stored in the memory 104 associated with the electronic device 100 in order to control the overall operation of the electronic device 100. The processor 102 is also capable of executing other applications resident in the memory 104, such as, one or more applications for identifying pose features of a selected object from a real-world scene. The processor 102 may include any suitable number(s) and type(s) of processors or other devices in any suitable arrangement. For example, the processor 102 may be capable of natural language processing, voice recognition processing, object recognition processing, eye tracking processing, and the like. In an embodiment, the processor 102 may include at least one microprocessor or microcontroller. Example types of the processor 102 may include microprocessors, microcontrollers, digital signal processors, application specific integrated circuits, and discreet circuitry. The processor 102 may be capable of executing other processes and programs resident in the memory 104, such as operations that receive, store, and timely instruct by providing processing of various types of content. The processor 102 may be capable of moving data into or out of the memory 104 as required by an executing process.

In an embodiment, the processor 102 may be coupled to the I/O interface 106 that provides the electronic device with the ability to connect to other devices such as the client devices or servers. For example, the electronic device 100 can connect to and receive applications from an external device such as a server. The I/O 106 interface is the communication path between these accessories and the processor 102.

According to the embodiments described below, the processor 102 is configured to control a series of processes that allow the electronic device 100 to operate. The processor 102 may include one or multiple processors. The one or more processors included in the processor 102 may be circuitry such as System on Chip (SoC), Integrated Circuit (IC), etc. The one or more processors included in the processor 102 may be general-purpose processors such as a Central Processing Unit (CPU), Micro Processor Unit (MPU), Application Processor (AP), Digital Signal Processor (DSP), etc., graphic-specific processors such as a Graphic Processing Unit (GPU), Vision Processing Unit (VPU), artificial intelligence-specific processors such as a Neural Processing Unit (NPU), or communication-specific processors such as a Communication Processor (CP). In an example case in which the one or more processors included in the processor 102 are artificial intelligence-specific processors, these AI processors may be designed with hardware architecture specialized for processing specific AI models.

The processor 102 may write data to the memory 104 or read data stored in the memory 104, and specifically, may process data according to predefined operational rules or AI models by executing programs or at least one instruction stored in the memory 104. Therefore, the processor 102 may perform the operations described in subsequent embodiments, and unless otherwise specified, the operations described as being performed by the electronic device 100 or detailed components included in the electronic device 100 in subsequent embodiments may be considered as being performed by the processor 102.

The memory 104 is configured to store various programs or data and may include storage media such as ROM, RAM, hard disk, CD-ROM, DVD, or a combination of these storage media. The memory 104 may not exist separately but may be configured to be included in the processor 102. The memory 104 may include volatile memory, non-volatile memory, or a combination of both volatile and non-volatile memory. Programs or at least one instruction for performing the operations according to the embodiments described later may be stored in the memory 104. The memory 104 may provide the stored data to the processor 102 at the request of the processor 102.

In an embodiment, the electronic device 100 may include a camera 108 for capturing the RGB image frames including one or more objects from the real-world scene. For example, the RGB image frames may be temporal prediction frames (e.g., T-frames). For example, the camera 108 may be a Time of Flight camera (ToF camera). In an embodiment, the plurality of RGB image frames may be real-time RGB images. In an embodiment the electronic device 100 may acquire at least one RGB image frame from the plurality of RGB image frames for predicting the plurality of pose features. In an embodiment, the at least one image frame may be fetched from a database associated with the electronic device. In an embodiment, the electronic device 100 may include at least one depth sensor 110 for capturing the depth information of the one or more objects from the real-world scene. The depth information may include 3D images and depth maps of the one or more objects. In an embodiment, the at least one depth sensor 110 in the electronic device 100 may include, but not limited to, a Time of Flight (ToF) sensor, LiDAR, binocular depth sensor, or structured-light sensors, or any other sensor that may provide more accurate depth information. In an another embodiment, the electronic device 100 may use the captured RGB image frames to determine the depth information of the one or more objects from the real-world scene.

According to embodiments of the disclosure, the electronic device 100 may include a Graphical User Interface (GUI) such as a display 112 that allows a user to view content displayed on the display 112 and interact with the electronic device 100. The content displayed on a display screen of an electronic device 100 can include user interface objects such as icons, images, videos, control elements such as buttons and other graphics, and the like. The user may interact with the user interface objects via a user input device, such as a keyboard, mouse, a touchpad, a controller, as well as sensors able to detect and capture body movements and motion. In an example case in which the display includes a touch panel, such as a touchscreen display, the user may interact with the content displayed on the electronic device by simply touching the display via a finger of the user or a stylus. In an example case in which the display is a Head-Mounted Display (HMD) and includes motion sensors or eye tracking sensors, the user may interact with the content displayed on the electronic device 100 by simply moving a portion of their body that is connected with the motion sensor. It is noted that as used herein, the term “user” may denote a human or another device (e.g., an artificial intelligent electronic device) using the electronic device.

FIG. 1B shows an exemplary architecture for generating a virtual 3D object in accordance with an embodiment of the disclosure. In an embodiment, electronic device 100 may receive the plurality of RGB image frames captured using the camera 108. Although some embodiments of the disclosure describe using RGB image frames, the disclosure is not limited thereto, and as such, another types of image frames (e.g., YUV YCbCr frames may be used. Upon receiving the plurality of RGB image frames, the electronic device 100 may extract RGB information associated with a selected object of one or more objects in at least one RGB image frame captured. For example, the plurality of RGB image frames from the real-world scene could contain several objects, such as a laptop, a coffee mug, keyboard, or a stack of books. In an embodiment, the user operating the electronic device 100 may be prompted to select at least one object from the one or more objects in the RGB image frame. The electronic device 100 may thereafter receive a selection of an object from the one or more objects, from the user, via the I/O interface 106. In another embodiment, the electronic device 100 may select an object from the one or more objects, randomly, or based on the user's previous selections, or a current context. Upon receiving the plurality of RGB image frames, the electronic device 100 may extract RGB information associated with the selected object, for example, a mug from the one or more objects of the RGB image frame captured. However, it should not be limited to the above examples. The electronic device may perform the operations for the selected object on all objects in the RGB image frame without selecting one of at least one object in the RGB image frame, or may perform the operations for the selected object on one of those objects.

According to an embodiment of the disclosure, RGB information may refer to feature maps obtained from RGB image frames or data derived from those feature maps. Accordingly, in this disclosure, ‘RGB information’ may be replaced with or interpreted as ‘feature map’. In one embodiment, RGB information (or feature map) may be obtained by applying the RGB image frame to an encoder. In one embodiment, the encoder may include multiple neural network layers such as convolutional layers, activation functions, pooling layers, and fully connected layers. In one embodiment, ‘RGB information’ may include features associated with objects contained in the RGB image frame.

In an embodiment, the electronic device 100 may also capture depth information of the selected object through the at least one depth sensor 110 associated with the electronic device 100. The electronic device 100 may further identify a category of the selected object from a plurality of pre-stored object categories, based on the RGB information of the selected object. Further, the method may include generating, by the electronic device 100, a contour mask of the selected object based on the feature map. Further, a 3D point cloud of a selected object may be generated based on the identified category, the contour mask and the depth information associated with the selected object. In an embodiment, the electronic device 100 may predict a plurality of pose features of the selected object for representation in a 3D virtual space based on the contour mask and the 3D point cloud associated with the selected object. Finally, the electronic device 100 may generate a virtual 3D object of the selected object based on application of a texture corresponding to the selected object and the predicted plurality of pose features on to the 3D point cloud of the selected object. In an embodiment, the electronic device 100 may also generate the virtual 3D object of the selected object by applying a texture corresponding to the selected object and the predicted plurality of pose features on to a 3D object mesh generated for the selected object.

In an embodiment, electronic device 100 may be configured to present the generated virtual 3D object of the selected object as a digital content to the user on the display 112 of the electronic device 100. The display 112 may be configured to include one or more display technologies. For example, the display 112 may be configured to display overlaying a new texture 3D model of the selected object onto the actual real-world object with accuracy and absolute size. In an embodiment, the electronic device 100 may use projectors to overlay digital content directly onto real-world objects using projection mapping techniques. In another embodiment, the electronic device 100 may project the digital content onto transparent screens mounted in front of the user. In an embodiment, the digital content may be overlaid onto the real-world object through the screen of a handheld device, like a smartphone or tablet. In an example case in which the keyboard is the selected object from the RGB image frame, a colorful layer that highlights different keys and edges of the keyboard may be one of the textures of the keyboard. Based on the predicted pose features, the texture of the keyboard is first converted into an absolute scale, translation and orientation as that of the keyboard in the captured RGB image frame, and overlaid or in other words applied on to one of a 3D point cloud or a 3D object mesh of the keyboard [selected object], and thereby generating the virtual 3D object. In this example, the virtual 3D object is the keyboard overlayed with the colorful texture which is adjusted in accordance with the predicted pose features.

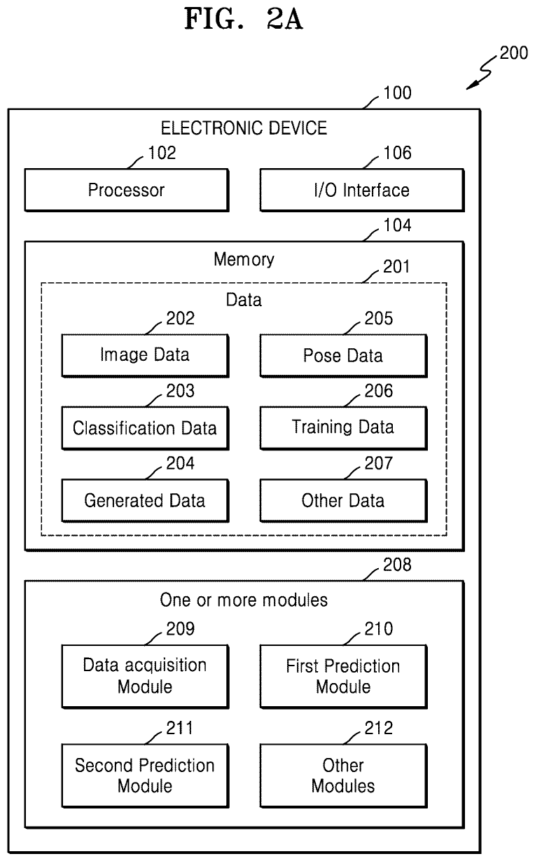

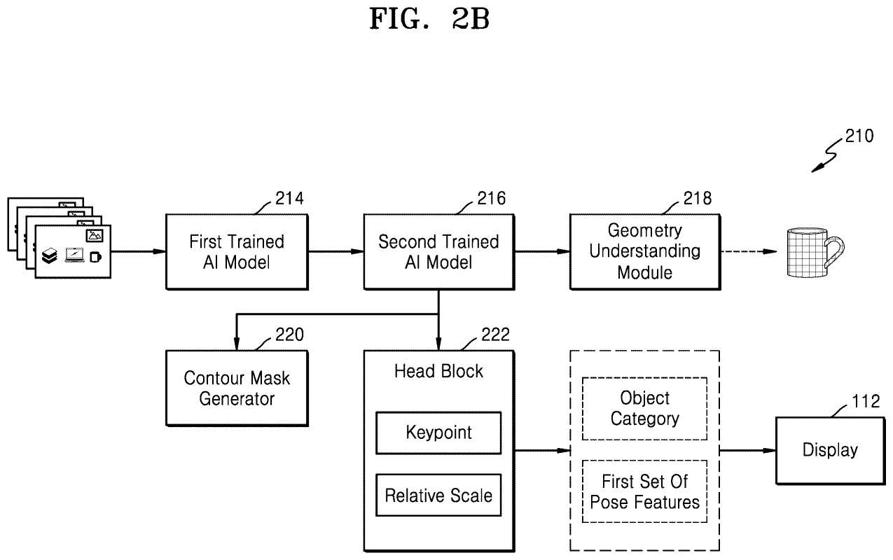

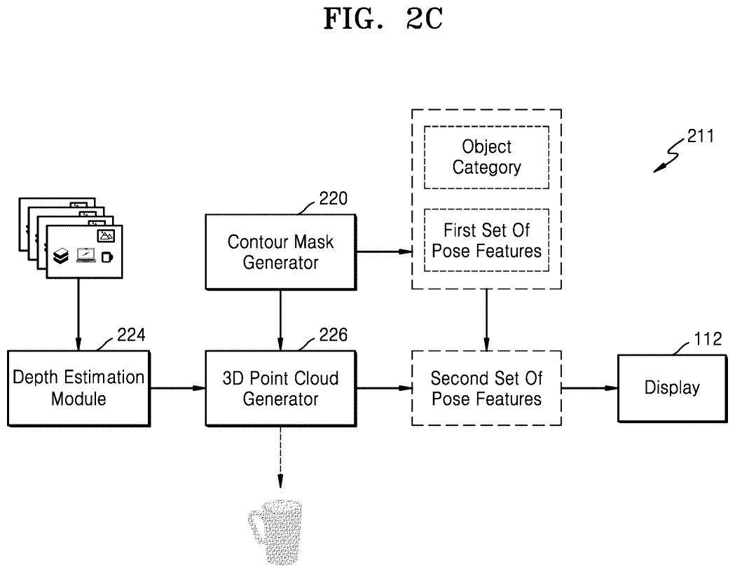

FIG. 2A shows a detailed block diagram 200 of the electronic device 100, in accordance with an embodiment of the disclosure.

In some embodiments, electronic device 100 may include a processor 102, a memory 104 and an I/O interface 106. In an embodiment, the memory 104 may be communicatively coupled to the processor 102. The processor 102 may be configured to perform one or more functions of the electronic device 100, using data 201 and one or more modules 208 of the electronic device 100. In an embodiment, the memory 104 may store the data 201.

In an embodiment, the data 201 stored in the memory 104 may include, but is not limited to, image data 202, classification data 203, generated data 204, pose data 205, training data 206, and other data 207. In some embodiments, the data 201 may be stored within the memory 104 in the form of various data structures. In an embodiment, the data 201 may be organized using data models, such as relational or hierarchical data models. The other data 207 may include various temporary data and files generated by the one or more modules.

In an embodiment, the image data 202 may include the plurality of RGB image frames captured or received by the electronic device 100. In an embodiment, the image data 202 may be stored temporarily until the process of predicting pose features is completed. In an embodiment, the image data 202, may include RGB information associated with one or more objects in at least one RGB image frame captured by the electronic device 100. In an embodiment, the RGB information may include, but not limited to, at least one of an object mesh indicating geometry of the one or more objects, a plurality of keypoints indicating vertices of a 3D bounding volume of each of the one or more objects in the at least one RGB image frame and a corresponding relative scale of each of the one or more objects, based on the pixel regions corresponding to the position of each of the one or more objects in the at least one RGB image frame. In an embodiment, the image data 202 may include pixel values of each pixel in the RGB image represented by three 8 bit numbers associated to the Red, Green, and Blue channels. These values may range from 0 to 255. In an embodiment, the image data 202 may also include color information, the combination of red, green, and blue values that gives rise to millions of colors. The one or more objects in the RGB image may have its unique combination of RGB values that represents its color. In an embodiment the image data 202 may include one or more portions or segments of the received RGB image frames, which contains one or more objects in the received image. In an embodiment, the image data 202, may also include depth information of the one or more objects in the at least one RGB image frame. The depth information may be acquired by the electronic device 100 from at least one depth sensor such as a depth sensing camera. As an example, the depth information may include depth images or depth maps. The depth maps may contain information relating to the distance of the surfaces of the object in the real-world scene from a viewpoint.

In an embodiment, the classification data 203 may include data related to categories or classes that the one or more objects may be classified into. In an embodiment, the classification data 203 may also include feature vectors, which are mathematical representations of an object's features used for classification. The classification data 203 may also include classification labels. Classification labels are the labels assigned to the one or more objects after classification. For example, in an image used by an electronic device 100, the one or more objects may be classified and labeled as “chair”, “table”, “person”, etc. In an example case in which the classification data 203 includes data related to an object ‘mug’, including its features, classification label (‘mug’), and 3D position this data can be used for future reference or for further processing by the electronic device 100.

In an embodiment, the data 201, may also include generated data 204. In an embodiment, the generated data 204 may include a contour mask of the one or more objects. The contour mask may be a binary image that outlines the shape of the one or more objects. In an embodiment, the generated data 204 may also include a semantic segmentation map, which gives a more detailed version of the contour mask that labels each pixel in the image according to the identified category object it belongs to. In an embodiment, the generated data 204 may include a 3D point cloud of one or more objects. In an embodiment the generated data 204 may include a 3D representation of the one or more objects, position, and orientation of recognized one or more objects in the RGB image frames, shape of the one or more objects in the RGB image frame, position of the one or more objects relative to each other and the like.

In an embodiment, the pose data 205 may include a plurality of pose features of the one or more objects. The plurality of pose features may include a first set of pose features related to rotation and translation of the selected object, and a second set of pose features related to rotation, translation and size of the selected object. For instance, the plurality of pose features may correspond to nine Degrees of Freedom (9-DoF) including rotation along x-axis, y-axis and z-axis, translation along x-axis, y-axis and z-axis, and size (absolute scale) along x-axis, y-axis and z-axis. In an embodiment, the image data 202 may be provided to the one or more modules of the electronic device 100 for further processing and determining the plurality of pose features. For instance, the image data 202 may be provided to a first prediction module 210 for predicting the first set of pose features of the selected objects in the received RGB image.

In an embodiment, the training data 206 may include data collected and pre-generated for training the electronic device 100 for generating the virtual 3D object of the selected object based on application of a texture corresponding to the selected object and the predicted plurality of pose features on to the 3D point cloud of the selected object. In an embodiment, the training data 206 may include training RGB image frames and training 3D point clouds. In an embodiment, various preprocessing may be performed on the training RGB image frames or training 3D point clouds, which may be used to train the AI models associated with one or more modules of the electronic device 100. For training the electronic device 100, the training data 206 may be provided to Artificial Intelligence (AI) models associated with the one or more modules of the electronic device 100. The training data 206 may be images or videos collected from real-world scene/environment. In an embodiment, the training data 206 may be gathered from online resources, or even generated through simulations. The training data 206 may be pre-processed before the training data 206 is used for training. In an embodiment, the preprocessing may include annotating the gathered data, cleaning the gathered data to remove noise, irrelevant information, normalizing the data to a standard format, and segmenting the data into meaningful units. In an embodiment, the training data 206 may include annotation files generated during pre-generation of training data set. The annotation files may include annotations of the reference objects of interest that serves as the training dataset for training the electronic device 100. In an embodiment, the training data 206 may be divided into batches. Each batch may be fed into the electronic device 100 during the training phase. The electronic device 100 may analyze the data, make predictions, and adjust its internal parameters based on the difference between its predictions and the actual outcomes. This iterative process may continue until the predictions of electronic device 100 reach an acceptable level of accuracy.

In an embodiment, the other data 207 may include metadata related to the plurality of RGB image frames or the training data 206. The metadata may also include additional information about the objects, such as the time and location of capture, device used for the capture, and the like.

In an embodiment, the data may be processed by the one or more modules 208 of the electronic device 100. In some embodiments, the one or more modules 208 may be communicatively coupled to the processor 102 for performing one or more functions of the electronic device 100. In an implementation, the one or more modules 208 may include, without limiting to, a data acquisition module 209, a first prediction module 210, a second prediction module 211, and other modules 212.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the one or more modules 208 may be configured as stand-alone hardware computing units. In an embodiment, the other modules 212 may be used to perform various miscellaneous functionalities on the electronic device 100. It will be appreciated that, such one or more modules 208 may be represented as a single module or a combination of different modules.

In an embodiment, data acquisition module 209 may be configured to acquire the captured at least one RGB image frame or an input video from the electronic device 100. For example, the user may hold the electronic device 100 in view of the real-world scene, for example a workspace to capture real-time images, having one or more objects. The captured images may be acquired by the data acquisition module 209. The real-time images may be a plurality of RGB image frames. As an example, the at least one RGB image frame from the real-world scene may include one or more objects such as a pile of books, a picture frame, a mug, and a laptop. In an embodiment, the modules may perform the method on preview of the real world scene before capturing the at least one RGB image frame.

In an embodiment, data acquisition module 209 may be configured to acquire depth information of the one or more objects in the at least one RGB image frame from a depth sensor 110 such as a depth sensing camera. As an example, the depth information may include depth images or depth maps. The depth maps may contain information relating to the distance of the surfaces of the object in the real-world scene from a viewpoint. For example, each pixel (of the acquired image) in the depth map may be assigned a value to represent the distance of that pixel from a specific reference point, like a camera lens, e.g., a distance value (Z) for each pixel (X, Y) in the RGB image frame. The distance may be expressed in metric units (like meters) and may be calculated from the back of eye of the depth sensing camera to the scene object. In another embodiment, the data acquisition module 209 may be configured to acquire input from one or more sensors, for example a ToF sensor that measures the depth or distance to an object by emitting an infrared beam of light and measuring the time it takes for the light to return.

In an embodiment, the data acquisition module 209 may receive the plurality of RGB image frames (e.g., T-frames) from the camera 108 associated with the electronic device 100. In another embodiment, the data acquisition module 209 may receive the plurality of RGB image frames from a database associated with the electronic device 100. In an embodiment, the electronic device 100 may extract RGB information associated with the one or more objects in the captured image frame. In an embodiment, the electronic device 100 may extract RGB information associated with only a selected object of the one or more objects in the captured RGB image frame. For extracting the RGB information associated with the selected object of one or more objects in at least one RGB image frame, the data acquisition module 209 may convert at least one RGB image frame of the received plurality of RGB image frames to high level feature map vector representation. In an embodiment, the data acquisition module 209 may be a Convolutional Neural Network (CNN), for example GhostNet to generate high level feature map vector representation from the RGB image frame. The RGB image frame may be passed through the CNN, which involves several layers of convolution, non-linear activation functions, and pooling operations that transform the RGB image frame. The output of the CNN may be a set of high-level feature map vector representation. These high-level feature map vector representations are high-level representations of the RGB image frame and may highlight the most important features of the RGB image frame, such as one or more objects in the RGB image frame and pixel regions corresponding to position of each of the one or more objects.

In an embodiment, the electronic device 100 may include a first prediction module 210. The first prediction module 210 may be implemented through one or more AI models. A function associated with the AI models may be performed through memory 104 and the processor 102. The processor 102 control the processing of the input data in accordance with a predefined operating rule or the AI models stored in a non-volatile memory and a volatile memory. The predefined operating rule or artificial intelligence model may be provided through training or learning. In an embodiment, the electronic device 100 may also include the second prediction module 211, for predicting the plurality of pose features. The second prediction module 211 may be implemented through one or more AI models.

FIG. 2B shows an exemplary block diagram of the first prediction module 210. In an embodiment, the first prediction module 210 may include a first trained AI model 214, a second trained AI model 216, a geometry understanding module 218, a contour mask generator 220, and a head block 222. However, the disclosure is not limited thereto, and as such, some modules or models may be omitted from the first prediction module 210, or new modules or models may be included in the first prediction module 210.

In one embodiment, the first prediction module 210 may be trained based on training RGB image frames. In one embodiment, the electronic device 100 may obtain the feature map by applying at least one image frame to the first prediction module 210. In one embodiment, the first prediction module 210 may be trained based on a reconstruction loss calculated using a mesh representation of the shape of an object included in the training RGB images.

In an embodiment, the first prediction module 210 may extract RGB information associated with a selected object of one or more objects in at least one RGB image frame captured by the electronic device 100. In an embodiment, extracting the RGB information of the selected object may include extracting feature representation of the one or more objects in the at least one RGB image frame, and pixel regions corresponding to position of the one or more objects in the at least one RGB image frame based on the feature representation of the one or more objects. In an embodiment, to extract the RGB information, the first prediction module 210 may use the first trained AI model 214 of the first prediction module 210 that may receive the plurality of RGB image frame from the data acquisition module 209. In an embodiment, the first trained AI model 214 may consider at least one RGB image frame from the plurality of RGB image frames and may extract feature representation of the one or more objects in the RGB image frame and pixel regions corresponding to position of the one or more objects in the at least one RGB image frame based on the feature representation of the one or more objects. The feature representation of the one or more objects may include high-level feature map representation. The first trained AI model 214 may apply a series of convolutional and pooling layers that progressively extract higher level features from the RGB image frame. In an embodiment, the first trained AI model 214 may receive a set of high level feature map vector representations of the RGB image frame from the data acquisition module 209. In an embodiment, the first trained AI model 214 may be a Path Aggregation Network (PAN). The feature map vector representation received may be passed through the PAN. The PAN may be designed to enhance the feature hierarchy of the received feature map vector representation which results in multi-scale feature representations. In an embodiment, the first trained AI model 214 may be a combination of a CNN and the PAN. The output of the first trained AI model 214 may be a set of multi-scale feature representations, which may be used to detect objects of different sizes at different levels of the high-level feature map representation.

In an embodiment, the first trained AI model 214 may also generate a Region of Interest (ROI) two dimensional (2D) box information associated with the one or more objects (2D projected 8 corner point locations) based on the set of multi-scale feature representations. The ROI may indicate pixel regions corresponding to the position of each of the one or more objects in the RGB image frame.

In an embodiment, the set of multi-scale feature representations, may be provided as an input to a second trained AI model 216 related to a Transformer Attention Network (TAN). The second trained AI model 216 may generate TAN-based feature representations based on the set of multi-scale feature representations from the PAN. In an embodiment, the input to the second trained AI model 216 may be the set of multi-scale feature representations and the ROI 2D box information associated with the one or more objects. The set of multi-scale feature representations would contain rich contextual information from different scales of the RGB image frame, and the ROI 2D box information would specify the regions in the image that are of interest. Upon receiving the input, the second trained AI model 216 may then process this input using the processor 102. The generated TAN-based feature representations would be feature representations that have been processed with the attention mechanism. These feature representations would be more focused on the regions of interest in the image, making them potentially more useful for tasks like object detection or segmentation.

In an embodiment extracting the RGB information of the selected object may also include predicting at least one of an object mesh indicating geometry of the one or more objects, a plurality of keypoints indicating vertices of a 3D bounding volume of each of the one or more objects in the at least one RGB image frame and a corresponding relative scale of each of the one or more objects, based on the pixel regions corresponding to the position of each of the one or more objects in the at least one RGB image frame. In an embodiment, the generated TAN-based feature representations may be provided as input to the geometry understanding module 218 of the first prediction module 210. In an embodiment, the geometry understanding module 218 may be a convolutional neural network (CNN). The TAN-based feature representations may be processed through a few layers of the CNN. The geometry understanding module 218 is used to understand the underlying geometry of the one or more objects in the RGB image frame. In an embodiment, the geometry understanding module 218 may understand the underlying geometry of the selected object of one or more objects in the at least one RGB image frame. In an embodiment, the geometry understanding module 218 may compute the object mesh for each of the one or more objects in the RGB image frame. In another embodiment, the geometry understanding module 218 may compute the object mesh for the selected object in the RGB image frame. The object mesh may be representation of a 3D object as a set of points (vertices) connected by lines (edges) to form flat surfaces (faces). The object mesh may contain ‘M’ number of vertices. The number of vertices may vary from object to object. The ‘M’ number of vertices of the object mesh may be sampled for example, using Poisson disk probabilistic sampling, to obtain a fixed number of geometric keypoints, or geometric points (GP). The Poisson disk probabilistic sampling may evenly distribute the geometric keypoints on the object surface.

In one embodiment, a plurality of keypoints indicating vertices of a 3D bounding volume of the object in the at least one RGB image frame may be predicted based on the feature map. In one embodiment, pixel regions corresponding to the position of the object in the at least one RGB image frame may be extracted based on the plurality of keypoints. In one embodiment, the contour mask may be generated by masking features corresponding to the object in the feature map based on the pixel regions and the feature map.

In an embodiment, a pre-computed Ground Truth (GT) points or GT pose information corresponding to an object may be used as a reference to understand the underlying geometry of the one or more objects in the RGB image frame. A pose transformation and rotation may be applied on the GT points to get the same pose as the object present in the RGB image frame. For instance, consider the object ‘mug’ in the RGB image frame, that has certain geometric points defined on its mesh. Using the ground truth points as a reference, pose transformation and rotation may be applied to the GT points. This way, the same pose for the ‘mug’ in the RGB image frame as it is in the ground truth is achieved. The geometry understanding module 218 may help to learn the geometry of the one or more objects in the RGB image frame.

In an embodiment, the underlying geometry of the selected object of one or more objects in the at least one RGB image frame may be used to identify a category of the selected object from a plurality of pre-stored object categories, based on the RGB information of the selected object. The pre-stored categories may be stored as classification data 203 in the memory 104.

In an embodiment, the contour mask generator 220 of the first prediction module 210 may generate a contour mask of the selected object based on the identified category of the selected object.

In an embodiment, the generated TAN-based feature representations may be provided as input to the contour mask generator 220 to generate a contour mask of one or more objects in the RGB image frame. In an embodiment, the contour mask generator 220 may be a convolutional neural network (CNN). The contour mask generator 220 may generate the contours of the objects in the image by classifying each pixels of the one or more objects, based on the generated TAN-based feature representations, as belonging to an object contour or not. Once the contours are predicted, a binary mask may be generated. For example, the binary mask is generated such that the pixels belonging to the object contours may be set to one (or a specified value), and all other pixels may be set to zero. In an embodiment, the geometry of the one or more objects in the RGB image frame may also be used by the contour mask generator 220 to generate a contour mask of one or more objects in the RGB image frame.

In an embodiment, the generated TAN-based feature representations may be provided as input to the head block 222. The head block 222 in the first prediction module 210 may include a set of convolution block layers. In an embodiment, the head block 222 may use the generated ROI 2D box information associated with the one or more objects to determine a plurality of keypoints indicating vertices of a 3D bounding volume of each of the one or more objects in the RGB image frame. The plurality of keypoints may be generated by regressing the location of 2D information, which may include the coordinates (x, y) of the 8 corner points of a cuboid.

In an embodiment, the head block 222 may also generate a relative scale associated with the one or more objects in the RGB image frame, based on the pixel regions corresponding to the position of each of the one or more objects. The relative scale includes the scale (length, width) of each the one or more objects. In an embodiment, the depth information of the one or more objects may be considered as ‘1’, and the length and width may be relative to the depth. In an embodiment the relative scale and the plurality of keypoints may be used to estimate the pose of the one or more objects. As an example, a Perspective-n-Point (PnP) solver may be used to estimate the pose (rotation and translation) of the one or more objects in the RGB image frame. The PnP solver may return rotation vectors and translation vectors of the one or more objects in the RGB image frame using the relative scale and the plurality of keypoints associated with the one or more objects. In an embodiment, extracting the RGB information of the selected object may further include extracting for the selected object of the one or more objects in the at least one RGB image frame, the feature representation of the selected object, pixel regions corresponding to the position of the selected object, the object mesh indicating geometry of the selected object, the plurality of keypoints indicating vertices of the 3D bounding volume of the selected object and the corresponding relative scale of the selected object, as the RGB information associated with the selected object.

In an embodiment, the first prediction module 210 may also predict a category of the selected object from a plurality of pre-stored object categories, based on the RGB information of the selected object. As an example, for an RGB image frame including one or more objects such as a pile of books, a picture frame, a mug, and a laptop scene, each one or more objects belong to a different category. The respective categories of the one or more objects may be stored in the memory associated with the electronic device 100. For instance, the mug is one category of object present in the RGB image frame. Other categories in the same RGB image frame may include ‘books’, ‘picture frames’, and ‘laptops’. The first prediction module 210 may display the category of the one or more objects in the same RGB image frame to the user. In an embodiment, the category of the one or more objects may be displayed by using a bounding box drawn around each one or more objects in the images. In an embodiment, the predicted category (e.g., ‘mug’, ‘book’, ‘laptop’) may be displayed next to the bounding box.

In an embodiment, the electronic device 100 may generate a first set of pose features of the selected object based on the extracted RGB information. The first set of pose features may be related to rotation and translation of the selected object. The first set of pose features may include rotation vectors and translation vectors of the selected object. As an example, for an RGB image frame including one or more objects such as a pile of books, a picture frame, a mug, and a laptop scene. For instance, the user may be prompted to select at least one object of interest from the one or more objects on the display 112. In an example case in which the user selects ‘mug’ from the one or more objects present in the RGB image frame, the first set of pose features of the mug e.g., 6 Degrees of Freedom (6DoF) including rotation of the mug along x-axis, y-axis and z-axis, and translation of the mug along x-axis, y-axis and z-axis may be provided to the user as display.

In an embodiment, the predicted categories and the object of interest may be included in the metadata associated with the plurality of RGB image frames and may be stored as other data 207 in the memory 104.

In an embodiment, the electronic device 100 may include the second prediction module 211. The second prediction module 211 may be implemented through one or more AI models. A function associated with the AI models may be performed through memory 104 and the processor 102. The processor 102 controls the processing of the input data in accordance with a predefined operating rule or the AI models stored in the non-volatile memory and the volatile memory. The predefined operating rule or artificial intelligence model may be provided through training or learning. The second prediction module 211 may generate a 3D point cloud of a selected object based on the identified category, the contour mask and the depth information associated with the selected object. Further, the second prediction module 211 may also predict a plurality of pose features of the selected object based on the RGB information and the 3D point cloud associated with the selected object. Predicting the plurality of pose features may include predicting a first set of pose features of the plurality of the pose features based on at least one of a plurality of keypoints, an object mesh and a relative scale of the selected object.

FIG. 2C shows an exemplary block diagram of the second prediction module 211. In an embodiment, the second prediction module 211 may include a depth estimation module 224, the contour mask generator 220, and a 3D point cloud generator 226. However, it should not be limited to this, and some modules or models may be omitted from the second prediction module 211, or new modules or models may be included in the second prediction module 211.

In one embodiment, the second prediction module 211 may be trained based on training 3D point clouds. In one embodiment, the electronic device 100 may obtain a plurality of pose features of the object by applying the contour mask and the 3D point cloud to the second prediction module 211. In one embodiment, the second prediction module 211 may be trained through a first training phase where the second prediction module 211 is trained alone, and a second training phase where the first prediction module 210 and the second prediction module 211 are trained together.

In an embodiment, the user may be prompted to select at least one object of interest from the one or more objects on the display 112. However, the disclosure is not limited thererto, and as such, the at least one object may be selected in another manner. The second prediction module 211 may predict second set of pose features of object selected by the user. As an example, in a case in which the user has selected mug, then the second prediction module 211 may predict second set of pose features of mug based on the contour mask and the first set of pose features of the selected object.

In an embodiment, the depth estimation module 224 may be configured to capture input from a depth sensing camera to create depth images or depth maps. The depth maps may contain information relating to the distance of the surfaces of scene objects from a viewpoint. For example, each pixel in a depth map may be assigned a value to represent the distance of that pixel from a specific reference point, like a camera lens, e.g., a distance value (Z) for each pixel (X, Y) in the image. The distance may be expressed in metric units (like meters) and may be calculated from the back of eye of the depth sensing camera to the scene object.

In an embodiment, depth information may be calculated by depth estimation module 224 from motion of the electronic device 100. As the electronic device 100 moves, the depth estimation module 224 may capture different views of the real-world scene, which may be used to estimate the depth of various objects in the scene. A function associated with the depth estimation module 224 may be performed through the memory 104 and the processor 102. In an embodiment, the captured plurality of RGB image frames along with the depth information may be stored as image data 202.

In an embodiment, the depth information may be used by the 3D point cloud generator 226 to generate 3D point cloud of the one or more objects. In an embodiment, 3D point cloud generator 226 may be a 3D Graph Convolutional Network (3D GCN). In an embodiment, the 3D point cloud generator 226 may use the depth information and the contour mask of the selected object to generate 3D point clouds. The 3D point cloud may be generated by mapping each pixel in the contour mask to a 3D point using the depth information. This results in a set of points that represent the shape of the selected object in 3D space. In an embodiment, the generated 3D point clouds of the selected object may be sampled to reduce the scale of the generated 3D point clouds. The contour mask may help in localizing the region from where 3D point clouds of the selected object may be sampled. The sampled 3D point clouds include a subset of 3D points from the original 3D point cloud. Sampling may reduce the computational complexity of subsequent processing steps, as working with a smaller number of 3D points can be much faster and more efficient.

In an embodiment, the 3D point cloud generator 226 may obtain global features and per-point features of the sampled 3D point clouds. Global features may be referred to characteristics that capture information about the entire 3D point cloud. Global features may provide a holistic view of the object, capturing the overall structure and shape of the object represented by the 3D point cloud. Per-point features may be computed for each individual point in the 3D point cloud. Per-point features may capture local information about the object, such as the position, color, or normal of each points, in 3D point cloud. In an embodiment, the 3D point cloud generator 226 may concatenate the global feature and the per-point features to produce depth-based features. The 3D point cloud generator 226 may produce depth-based features of dimension NxC1, where N is the number of points sampled and C1 is the number of feature map channels (number of classes available in the classification data).

In an embodiment, the second prediction module 211 may predict second set of pose features related to rotation, translation and size of the selected object based on the first set of pose features of the one or more objects and the 3D point cloud of the selected object. The first set of pose features of the selected object may encode per pixel spatial 2D information of the selected object. In an embodiment, the RGB information of the selected object of the one or more objects obtained by the second prediction module 211 may be reduced into a predefined dimension using a feature sampling model to obtain compact RGB information of the selected object by reducing dimensionality of the RGB information of the selected object into a predefined dimension using a feature sampling model. The compact monocular feature may be of dimension NxC2, where N is the number of points sampled and C2 is the number of feature map channels (number of classes available in the classification data).

In an embodiment, the second prediction module 211 may fuse the compact RGB information of the selected object with the sampled 3D point cloud of the selected object from the 3D point cloud generator 226. In an embodiment, the fusion may be performed using multi-modal fusion technique. The multi-modal fusion may be considered as semantic fusion of the compact RGB information of the selected object with the sampled 3D point cloud of the selected object. In an embodiment, the multi-modal fusion may be concatenation of the compact RGB information of the selected object with the corresponding sampled 3D point cloud of the selected object. In another embodiment, the multi-modal fusion may be addition of the compact RGB information of the selected object with the corresponding sampled 3D point cloud of the selected object.

In an embodiment, the second prediction module 211 may predict the second set of pose features related to rotation, translation and size of the selected object based on an output of the fusion e.g., 9-DoF. 9-DoF (Degrees of Freedom) of the selected object pose prediction in an electronic device 100 significantly enhances the user experience. The electronic device 100 combines the first prediction mode (monocular method) and the second prediction mode (depth-based method) (first set of pose features and second set of pose features) for efficient 9-DoF prediction. In an embodiment, the electronic device 100 may generate a virtual 3D object of the selected object based on application of a texture corresponding to the selected object and the predicted plurality of pose features on to the 3D point cloud of the selected object. For example, the electronic device 100, such as an AR device, processes any captured image from real-world scenes and overlays digital information (like 3D models, text, or animations) onto a user's view of the real-world scene, thereby enhancing the user experience.

In an embodiment, the electronic device 100 may include other modules 212. The other modules 212 may include a training module. In an embodiment the other modules 212 may also include a data collection module. In an embodiment, other modules 212 may also include an annotation module, as discussed below.

In an embodiment, the electronic device 100 may operate in a plurality of modes of operation. The plurality of modes may include a first prediction mode or a second prediction mode. The electronic device 100, may switch to one of the first prediction mode or the second prediction mode, based on one or more predefined conditions. In the first prediction mode, the electronic device 100 may predict the first set of pose features of the selected object, using a first prediction module 210 as discussed above. Similarly, in second prediction mode, the electronic device 100 may predict the second set pose features, using a second prediction module 211 as discussed above.

In another embodiment, switching to one of the first prediction mode or the second prediction mode may be based on one or more predefined conditions. In an embodiment, the predefined condition may be availability of light in the real world scene. In an example case in which the light conditions are low, the electronic device 100 may switch to the second prediction mode that is designed to operate optimally under such conditions. The term “low light condition” may refer, for example, to a state in which the ambient illumination falls below a predefined threshold, such as less than 50 lux, or when the illumination is insufficient for accurate image capture by the device camera. However, such values are merely illustrative examples, and the invention is not limited thereto. In low light conditions, the second prediction mode may be automatically selected based on the lighting conditions and is capable of predicting the second set of pose features (9-Degrees of Freedom (9-DoF)).

In an embodiment, the predefined condition may be power status of the electronic device 100. In an example case in which the electronic device 100 is running low on power, the electronic device 100 might switch to a power-efficient mode. The expression “running low on power” may refer, for example, to a state in which the remaining battery capacity falls below a predefined threshold, such as 20% of full capacity, such that continuous operation in the second prediction mode cannot be sustained. The specific threshold value is provided as an illustrative example only, and other values may also be used depending on the design of the device. In power-efficient mode, the first prediction mode may be automatically selected based on the power status of the device. Despite being in a power-saving mode, the device may predict first set of pose features (6-Degrees of Freedom (6-DoF)). This switching to one of the first prediction mode or the second prediction mode may ensure that the electronic device 100 can continue to function effectively, providing necessary services to the user, while also adapting to the changing conditions, whether they are external (like lighting conditions) or internal (like power status).

In an embodiment, switching to one of the first prediction mode or the second prediction mode may be based on a user's requirement. As an example, the user uses an electronic device 100, such as AR glasses to capture a plurality of RGB image frames from the real-world scene. This scene could contain several objects, such as a laptop, a coffee mug, keyboard, or a stack of books. The electronic device 100 may detect these objects and may prompt the user to select an object of interest. For instance, the user selects the keyboard. Upon selecting the object of interest, the electronic device 100 may switch to one of the first prediction mode or second prediction mode, based on user requirement. In an example case in which the user selects first prediction mode, first set of pose features of the selected object may be displayed to the user e.g., 6 DoF of the selected object related to rotation and translation of the selected object. In another example case in which the user selects second prediction mode, second set of pose features of the selected object may be displayed to the user e.g., 9 DoF of the selected objected related to rotation, translation and size of the selected object, and such second set of pose features may be applied on to the 3D point cloud and/or the 3D object mesh of the selected object to generate a virtual 3D object of the selected object.

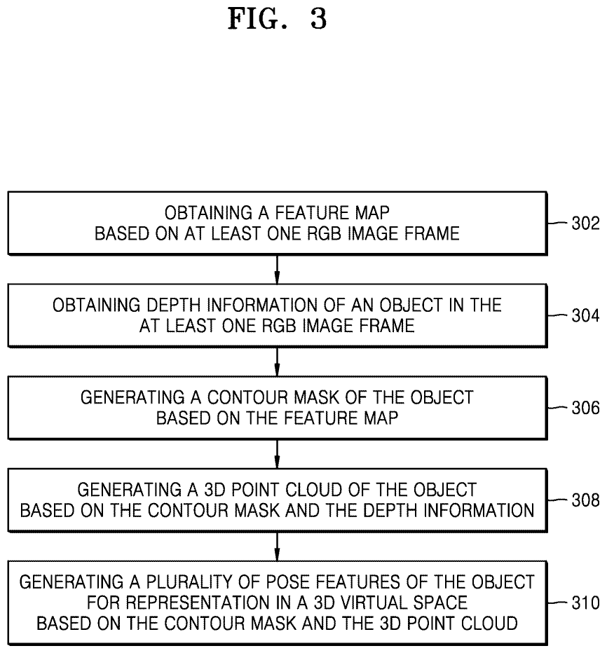

FIG. 3 shows an exemplary flowchart illustrating a method of generating a virtual 3D object by the electronic device 100. The method may be described in the general context of computer executable instructions. Generally, computer executable instructions can include routines, programs, objects, components, data structures, procedures, modules, and functions, which perform specific functions or implement specific abstract data types.

The order in which the method is described is not intended to be construed as a limitation, and any number of the described method blocks can be combined in any order to implement the method. In an embodiment, individual blocks may be deleted from the methods without departing from the scope of the subject matter described herein. Furthermore, the method can be implemented in any suitable hardware, software, firmware, or combination thereof.

According to an embodiment, in operation 302, the method includes obtaining a feature map based on at least one RGB image frame. In an embodiment, the method may include extracting, by an electronic device 100, RGB information associated with a selected object of one or more objects in at least one RGB image frame captured by the electronic device 100. In an embodiment, extracting the RGB information of the selected object may include extracting feature representation of the one or more objects in the at least one RGB image frame, and pixel regions corresponding to position of the one or more objects in the at least one RGB image frame based on the feature representation of the one or more objects. Further, the electronic device 100 may predict at least one of an object mesh indicating geometry of the one or more objects, a plurality of keypoints indicating vertices of a 3D bounding volume of each of the one or more objects in the at least one RGB image frame and a corresponding relative scale of each of the one or more objects, based on the pixel regions corresponding to the position of each of the one or more objects in the at least one RGB image frame. Finally, the electronic device 100 may extract for the selected object of the one or more objects in the at least one RGB image frame, the feature representation of the selected object, pixel regions corresponding to the position of the selected object, the object mesh indicating geometry of the selected object, the plurality of keypoints indicating vertices of the 3D bounding volume of the selected object and the corresponding relative scale of the selected object, as the RGB information associated with the selected object. In an embodiment, the feature representation is extracted using a first trained AI model 214 related to a Path Aggregation Network (PAN), and the pixel regions are extracted using a second trained AI model 216 related to a Transformer Attention Network (TAN).

According to an embodiment, in operation 304, the method includes obtaining depth information of an object in the at least one RGB image frame. For example, the depth information may be obtained through at least one depth sensor associated with the electronic device. In an embodiment, the method may include capturing, by the electronic device 100, the depth information of the selected object through at least one depth sensor associated with the electronic device.

In an embodiment, the method may include identifying, by the electronic device 100, a category of the selected object from a plurality of pre-stored object categories, based on the RGB information of the selected object.

According to an embodiment, in operation 306, the method includes generating a contour mask of the object based on the feature map. In an embodiment, the method may include generating, by the electronic device 100, a contour mask of the selected object based on the identified category of the selected object.

According to an embodiment, in operation 308, the method includes generating a 3D point cloud of the object based on the contour mask and the depth information. In an embodiment, the method may include generating, by the electronic device 100, a 3D point cloud of a selected object based on the identified category, the contour mask and the depth information associated with the selected object.

According to an embodiment, in operation 310, the method includes generating a plurality of pose features of the object for representation in a 3D virtual space based on the contour mask and the 3D point cloud. In an embodiment, the method may include predicting, by the electronic device 100, a plurality of pose features of the selected object based on the RGB information, and the 3D point cloud associated with the selected object. In an embodiment, predicting the plurality of pose features may include predicting a first set of pose features of the plurality of the pose features based on at least one of a plurality of keypoints, an object mesh and a relative scale of the selected object. The first set of pose features may be related to rotation and translation of the selected object, and the second set of pose features may be related to rotation, translation and size of the selected object. In an embodiment, predicting a second set of pose features of the plurality of pose features may include obtaining compact RGB information of the selected object by reducing dimensionality of the RGB information of the selected object into a predefined dimension using a feature sampling model. Further, the electronic device 100 may obtain a sampled 3D point cloud of the selected object from the 3D point cloud of the selected object by processing the 3D point cloud using a 3D Graph Convolutional Neural Network (GCN) Model. Predicting a second set of pose features may further include fusing the compact RGB information of the selected object with the sampled 3D point cloud of the selected object. Finally, the electronic device 100 may predict the second set of pose features of the selected object based on the fusion of the compact RGB information of the selected object with the sampled 3D point cloud of the selected object.

In an embodiment, the method may include generating, by the electronic device 100 a virtual 3D object of the selected object based on application of a texture corresponding to the selected object and the predicted plurality of pose features on to the 3D point cloud of the selected object.

In an embodiment, the electronic device 100 may be trained for predicting the plurality of pose features including at least one of, the first set of pose features and the second set of pose features of one or more objects in an RGB image frame.

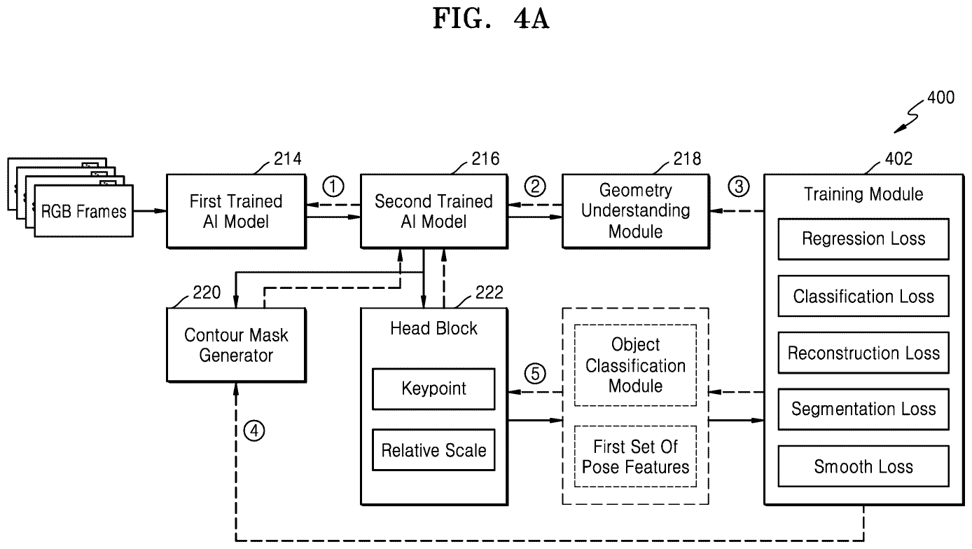

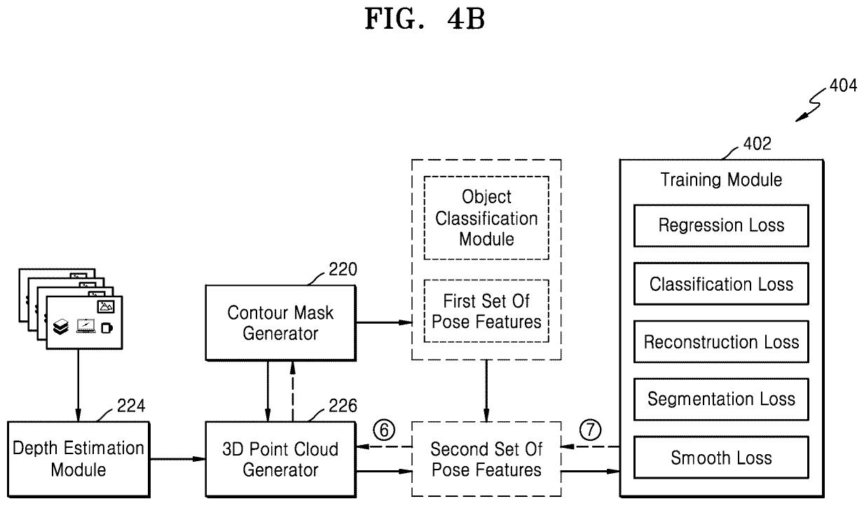

FIG. 4A shows an exemplary block diagram 400 for training the first prediction module 210 to operate in a first prediction mode, in accordance with an embodiment of the disclosure.

In an embodiment, the first prediction module 210 may be trained by the training module 402 for predicting the first set of pose features. In an embodiment, the training module 402 may use backpropagation (indicated as dotted lines in the figure). Backpropagation is an iterative algorithm that helps to minimize the cost function by determining which weights and biases should be adjusted. During every epoch, the first prediction module 210 may be trained by adapting the weights and biases to minimize the loss by moving down toward the gradient of the error.

In an embodiment, the first trained AI model 214 of the first prediction module 210 may be trained by the training module 402. The first trained AI model 214 may generate the Region of Interest (ROI) 2D box information associated with the one or more objects that indicates pixel regions corresponding to the position of each of the one or more objects in the RGB image frame. The first trained AI model 214 may be (1) trained by the training module 402 by predicting the pixel regions corresponding to position of the reference objects of interest in the training RGB image frame through classification loss. The classification loss function associated with the predicted the pixel regions corresponding to position of the reference objects of interest in the training RGB image frame may be used to estimate the error or loss of the model so that the weights can be updated in the first trained AI model 214 to reduce the loss on the next evaluation. The first trained AI model 214 may be trained by adapting the weights and biases to minimize the loss by moving down toward the gradient of the error.

In an embodiment, the second trained AI model 216 may be (2) trained by the training module 402 by predicting the pixel regions corresponding to position of the reference objects of interest in the training RGB image frame through classification loss. The classification loss function associated with the predicted the pixel regions corresponding to position of the reference objects of interest in the training RGB image frame may be used to estimate the error or loss of the model so that the weights can be updated in the second trained AI model 216 to reduce the loss on the next evaluation.

In an embodiment, the geometry understanding module 218 may be (3) trained by the training module 402 by predicting the geometry of the reference objects of interest in the training RGB image frame through a reconstruction loss. In an embodiment, the training module 402 may use the output of the geometry understanding module 218 for regressing geometric points (GP). The pre-computed Ground Truth (GT) points may be used as a reference for this regression task. The loss may be computed using a geometry understanding loss. As an example, the geometry understanding loss could be expressed through the Chamfer Distance or the Smooth L1 loss. The Chamfer Distance is a metric for comparing two point clouds. The Chamfer Distance considers the distance of each point in each cloud, finds the nearest point in the other point set, and sums up the square of the distances. The Smooth L1 loss is a type of loss function that is less sensitive to outliers than the Mean Squared Error loss. The Smooth L1 loss uses a squared term if the absolute element-wise error falls below a certain threshold (beta) and an L1 term otherwise. By propagating loss function back to the geometry understanding module 218, the training module 402, may adjust the parameters (weights and biases) related to the geometry understanding module 218 to better align the predicted and actual values, thereby improving the accuracy of the geometry understanding module 218 over time.

In an embodiment, the contour mask generator 220 may be (4) trained by the training module 402 by predicting a contour of the reference objects of interest in the training RGB image frame through a segmentation loss. In an embodiment, the contour mask generator 220 may predict the pixel-wise segmentation mask of the object. The contour mask generator 220 may be trained through a standard Binary Cross-Entropy loss, which is a common loss function for binary classification problems. The contour mask generator 220 may predict the pixel-wise segmentation mask of the object, trained through standard Binary Cross Standard loss. By propagating loss function back to the contour mask generator 220, the training module 402, may adjust the parameters (weights and biases) related to the contour mask generator 220 to better align the predicted and actual values, thereby improving the accuracy of the contour mask generator 220 over time.

In an embodiment, the head block 222 may be (5) trained by the training module 402 by predicting a plurality of keypoints and a relative scale of reference objects of interest in a training RGB image frame through a regression loss. As an example, the regression loss may be the Smooth L1 loss function. By propagating loss function back to the head block 222, the training module 402, may adjust the parameters (weights and biases) related to the head block 222 to better align the predicted and actual values, thereby improving the accuracy of the head block 222 over time.

In an embodiment, the regression loss, the classification loss, the reconstruction loss, and the segmentation loss may be computed using a pre-generated training dataset in the training data 206.

FIG. 4B shows an exemplary block diagram 404 for training the second prediction module 211 to operate in a second prediction mode, in accordance with an embodiment of the disclosure.

In an embodiment, the second prediction module 211 may be trained by the training module 402 for predicting the second set of pose features. In an embodiment, the training module 402 may use backpropagation (indicated as dotted lines in the figure).

In an embodiment, training second prediction module 211 for predicting the second set of pose features may include predicting the second set of pose features of reference objects of interest based on the RGB information and 3D point cloud of the reference objects of interest through a regression loss. As an example, second prediction module 211 may be trained for predicting the rotation, translation, and absolute size of the object through regression loss. In an embodiment, the regression loss may be computed using a pre-generated training dataset.

In an embodiment, the second prediction module 211 may be (6) trained by the training module 402 to fuse the compact RGB information of the selected object with the depth-based features of the selected object from the 3D point cloud generator 226 through regression loss. By propagating loss function back to the second set of pose features prediction module, the training module 402, may adjust the parameters (weights and biases) related to second prediction module 211 to better fuse the compact RGB information of the one or more objects with the 3D point cloud associated with the selected object, thereby improving the accuracy of the Second prediction module 211 over time.

In an embodiment, the second prediction module 211 may predict the second set of pose features including rotation, translation and size of the selected object based on an output of the fusion, (7), e.g., 9-DoF. In an embodiment, size of the selected object may also be refereed as absolute scale of the selected object in the context of the disclosure. In an embodiment, the orientation vectors or rotation vectors may include 3 values along x, y, z axis. The training module 402 may use Smooth L1 loss for regressing the rotation vectors as the Smooth L1 loss is more robust to outliers. In an embodiment, the translation vectors may include 3 values along x, y, z axis. The training module 402 may use regression loss function, for example Smooth L1 loss for training the second prediction module 211 to predict the translation values. In an embodiment, the second prediction module 211 may predict absolute scale of the one or more objects. The training module 402 may use regression loss function, for training the Second prediction module 211 to predict the absolute scale of the one or more objects. Training the first prediction module 210, and training the second prediction module 211, may provide a more scalable and flexible object detection and pose approach. The electronic device 100 can handle a wide range of object categories without the need for separate models for each category.

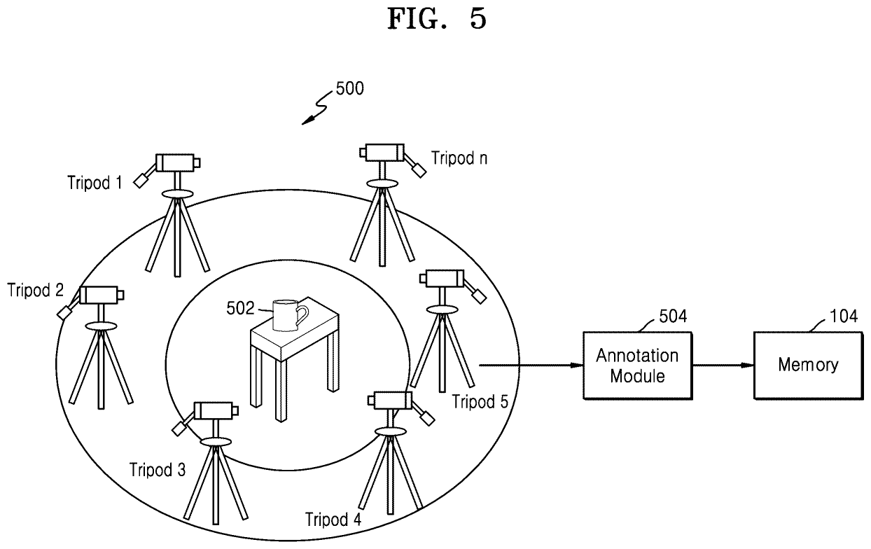

FIG. 5 shows a training setup 500 for pre-generating the training dataset for the electronic device 100.

In an embodiment, the training setup for pre-generating the training dataset for the electronic device 100, may include arranging a plurality of holders around a reference objects of interest, for mounting a first electronic device and a second electronic device associated with the first electronic device, as shown in the FIG. 5. The plurality of holders may be placed around a reference objects of interest 502 such that, the first electronic device and the second electronic device may capture the reference objects of interest 502 from a different field of view in an example case in which the first electronic device and the second electronic device are mounted to each of the plurality of holders. The first electronic device may capture RGB images (e.g. video) of the reference objects of interest 502 and the second electronic device may captures depth images of the reference objects of interest 502. As an example, the first electronic device is a mobile device having a camera and the second electronic device associated with the first electronic device may be RGB-D sensor (RGB-Depth sensor), a type of depth camera that provides both depth (D) and color (RGB) images as the output in real-time. In an embodiment, the first electronic device and the second electronic device may be synchronized to capture the RGB images and the depth images of the reference objects of interest respectively.

In an embodiment, the first electronic device and the second electronic device may be positioned at a first position at a first holder of the plurality of holders. At the first position, axis of the first electronic device and the second electronic device may be aligned with axis of the reference objects of interest. As an example, the object of interest 502 may be a ‘mug’ (as shown in figure) and may be placed in a scene with its axes aligned with the mobile camera's axis. The plurality of holders may be tripods (tripod 1-tripod n), such that each of them are at a 45-degree angle from the others, to capture a full 360-degree view of the scene.

In an embodiment, pre-generating the training dataset may include determining at the first position, initial ground truth values corresponding to the plurality of degrees of freedom of the reference objects of interest. As an example, the mobile device may capture the RGB images (or video) of the object of interest 502 and the RGB-D sensor may capture RGB and depth information of the object of interest 502. Further, the mobile device runs a software to estimate the ground values corresponding to location, rotation vectors and translation vectors of the object of interest 502 for a given timestamp. In an embodiment, the determined ground truth values may be annotated by an annotation module 504 for the reference objects of interest.

In an embodiment, pre-generating the training dataset may include determining at each subsequent position of the plurality of positions, subsequent ground truth values corresponding to the plurality of pose features of the reference objects of interest relative to the initial ground truth values. As an example, using the plurality of holders placed at a 45-degree angle from the others, the mobile device may capture RGB images (or video) of the object of interest 502 and the RGB-D sensor may captures RGB and depth information of the object of interest 502, at subsequent positions such that full 360-degree view of the object of interest 502 may be obtained. Further, the determined subsequent ground truth values at each subsequent position may automatically annotated by the annotation module 504 for the reference objects of interest.

In an embodiment, the annotation module 504 may generate an annotation file including annotations of the reference objects of interest that serves as the training dataset for training the electronic device 100. In an embodiment the annotation module 504 may automate the generation of the annotation file, allowing for the creation of a scalable dataset with minimal human involvement. For automating the generation of the annotation file, a developer may manually annotate the first frame of the captured video. Thereafter, the annotation module 504 may annotate all subsequent captured frames within the video. Thus, the annotation module 504 labels the reference object of interest with the correct pose information with less human intervention. Further, the annotation file may be stored in the memory 104. Pre-generating the training dataset may help in creating more diverse and representative datasets. Using the pre-generated data set may improve the accuracy and reliability of the pose, leading to better AR and VR experiences. Also, automating the generation of annotation files may significantly reduce the need for manual effort, which can be time-consuming and prone to errors. Automated generation of annotation files may also allow for the creation of large, diverse, and accurate datasets of one or more objects that are essential for training robust electronic devices.

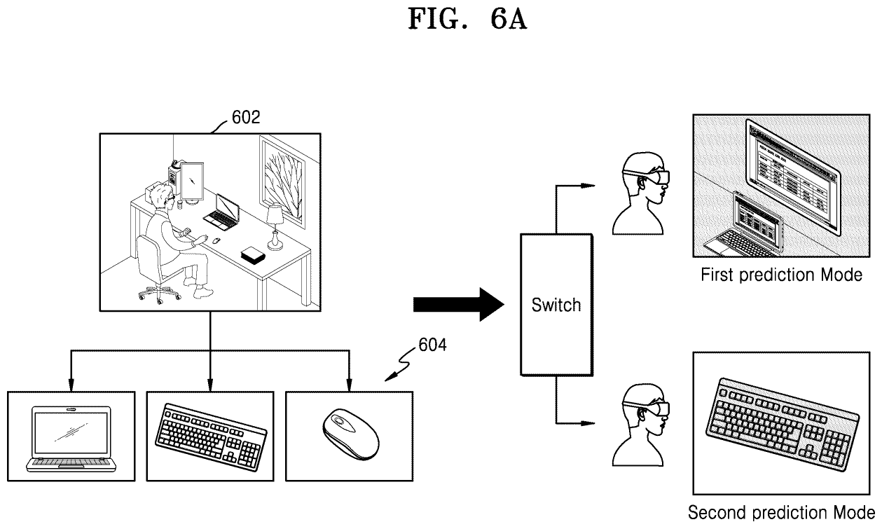

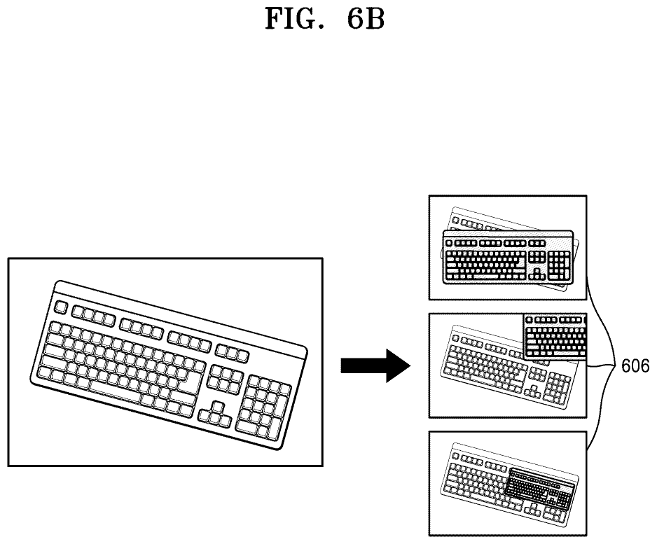

FIG. 6 illustrates an exemplary scenario of using the electronic device 100.

In an exemplary scenario, the user may use an AR device, such as AR glasses or a smartphone with AR capabilities, to capture a plurality of RGB image frames from the real-world scene 602. According to an embodiment, the AR device may be implemented as the electronic device 100. This scene could contain one or more objects 604, such as a laptop, a coffee mug, keyboard, or a stack of books. The electronic device 100 may detect these objects and may prompt the user to select an object of interest. For instance, the user selects the keyboard. Upon selecting the object of interest, the electronic device 100 may switch to one of the first prediction mode or a second prediction mode, based on user requirement. In an example case in which the user selects second prediction mode to predict the second set of pose features (9-DoF) for the selected object, e.g., the keyboard, the electronic device 100 may provide the user with options to select pre-stored templates to overlay a texture on the keyboard. For instance, the user might choose to overlay a custom skin design on the keyboard's surface. Upon selecting the custom skin design the custom skin may be overlaid onto the 3D point cloud or 3D object mesh of the actual keyboard, to provide an immersive AR experience for the user. Without the implementation of 9-DoF, using 6-DoF or 8-DoF, the results could be unsatisfactory (as shown in FIG. 6B). The overlay might not properly overlap on the keyboard, leading to a disjointed and unconvincing AR experience.

In another example scenario, the user may also project the digital content onto a transparent screen mounted in front of the user. In such scenario, the electronic device 100 may switch to first prediction mode to predict the 6-DoF pose for the selected object or digital content.

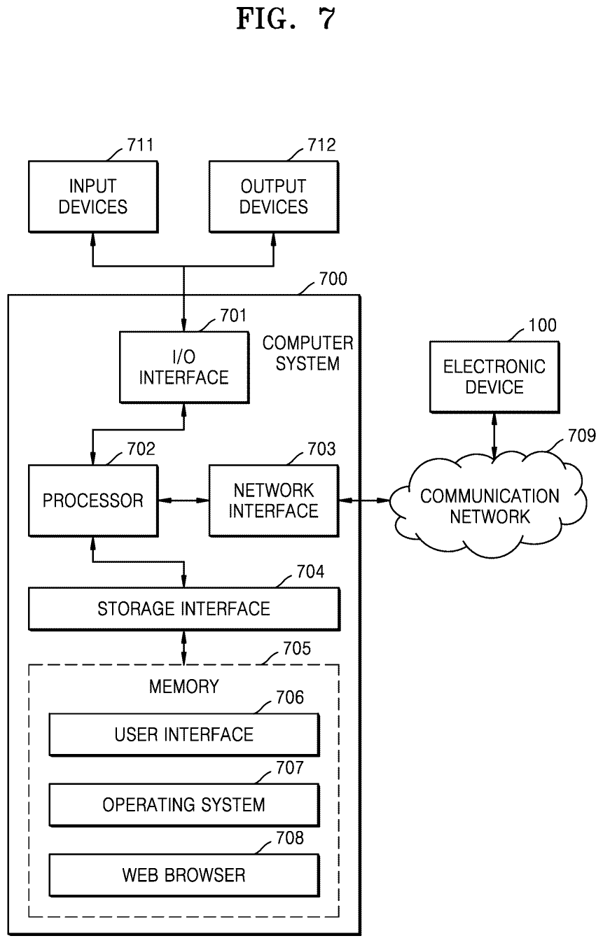

FIG. 7 is a block diagram of an exemplary computer system for implementing embodiments consistent with the disclosure.

In an embodiment, FIG. 7 illustrates a block diagram of an exemplary computer system 700 for implementing embodiments consistent with the present invention. In an embodiment, the exemplary computer system 700 may be an electronic device 100 that is used for generating a virtual 3D object associated with electronic device 100. As an example, the electronic device 100 may include, but not limited to, an AR device, VR device, a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device, or an immersive system. The exemplary computer system 700 may include a central processing unit (“CPU” or “processor”) 702. The processor 702 may include at least one data processor for executing program components for executing user or system-generated business processes. The processor 702 may include specialized processing units such as integrated system (bus) controllers, memory management control units, floating point units, graphics processing units, digital signal processing units, etc.

The processor 702 may be disposed in communication with input devices 711 and output devices 712 via I/O interface 701. The I/O interface 701 may employ communication protocols/methods such as, but is not limited to, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n //g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 701, exemplary computer system 700 may communicate with input devices 711 and output devices 712.

In an embodiment, the processor 702 may be disposed in communication with a communication network 709 via a network interface 703. The network interface 703 may communicate with the communication network 709. The network interface 703 may employ connection protocols including, but is not limited to, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 703 and the communication network 709, the exemplary computer system 700 may communicate with the electronic device 100, for which examples are mentioned in description of FIG. 1. The communication network 709 can be implemented as one of the different types of networks, such as intranet or Local Area Network (LAN), Closed Area Network (CAN) and such from the electronic device 100. The communication network 709 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 709 may include a variety of network devices, including routers, bridges, servers, computing devices, storage devices, etc. In an embodiment, the processor 702 may be disposed in communication with a memory 705 (e.g., RAM, ROM, etc. not shown in FIG. 7) via a storage interface 704. The storage interface 704 may connect to memory 705 including, but is not limited to, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, but is not limited to, a user interface 706, an operating system 707, a web browser 708 etc. In an embodiment, the exemplary computer system 700 may store user/application data, such as the data, variables, records, etc. as described in this invention. Such databases may be implemented as fault-tolerant, relational, scalable, secure databases such as Oracle or Sybase.

The operating system 707 may facilitate resource management and operation of the exemplary computer system 700. Examples of operating systems include, but is not limited to, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLETM ANDROIDTM, BLACKBERRY® OS, or the like. The User interface 706 may facilitate display, execution, interaction, manipulation, or operation of program components through textual or graphical facilities. For example, user interfaces may provide computer interaction interface elements on a display system operatively connected to the exemplary computer system 700, such as cursors, icons, check boxes, menus, scrollers, windows, widgets, etc. Graphical User Interfaces (GUIs) may be employed, including, but is not limited to, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In an embodiment, the exemplary computer system 700 may implement the web browser 408 stored program components. The web browser 708 may be a hypertext viewing application, such as MICROSOFT® INTERNET EXPLORER®, GOOGLETM CHROMETM, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 708 may utilize facilities such as AJAX, DHTML, ADOBE® FLASH®, JAVASCRIPT®, JAVA®, Application Programming Interfaces (APIs), etc. In an embodiment, the exemplary computer system 700 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In an embodiment, the exemplary computer system 700 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

According to an embodiment of the disclosure, the method of generating pose information about a virtual 3D object may include obtaining a feature map based on at least one RGB image frame captured by the electronic device. The method may include obtaining depth information of an object in the at least one RGB image frame through at least one depth sensor associated with the electronic device. The method may include generating a contour mask of the object based on the feature map. The method may include generating a 3D point cloud of the object based on the contour mask and the depth information. The method may include generating a plurality of pose features of the object for representation in a 3D virtual space based on the contour mask and the 3D point cloud.

According to an embodiment of the disclosure, the method may include predicting a plurality of keypoints indicating vertices of a 3D bounding volume of the object in the at least one RGB image frame based on the feature map. The method may include extracting pixel regions corresponding to position of the object in the at least one RGB image frame based on the plurality of keypoints. The method may include generating the contour mask by masking features corresponding to the object in the feature map based on the pixel regions and the feature map.

According to an embodiment of the disclosure, the plurality of pose features may include a set of pose features related to rotation, translation and size of the object.

According to an embodiment of the disclosure, the method may include obtaining a sampled 3D point cloud of the object from the 3D point cloud. The method may include fusing the contour mask with the sampled 3D point cloud. The method may include generating the plurality of pose features based on the fusion of the contour mask with the sampled 3D point cloud.

According to an embodiment of the disclosure, the method may include applying the at least one RGB image frame to a first AI model trained based on training RGB image frame to obtain the feature map. the first AI model may be trained based on a reconstruction loss calculated using a mesh representing the shape of the object included in the training RGB frame.

According to an embodiment of the disclosure, the method may include applying the contour mask and the 3D point cloud to a second AI model trained based on the point cloud of the training object to obtain the plurality of pose features of the object. the second AI model may be trained through a first training in which the second AI model is trained alone and a second training in which the first AI model and the second AI model are trained together.

According to an embodiment of the disclosure, the method may include obtaining user input selecting one of a plurality of candidate objects included in the at least one RGB frame. The method may include determining the selected object from the plurality of candidate objects as the object.

According to an embodiment of the disclosure, the electronic device for generating pose information about a virtual 3D object may include a memory storing one or more instructions and at least one processor configure to execute the one or more instructions stored in the memory. The at least one processor is configured to execute the one or more instructions to obtain a feature map based on at least one RGB image frame captured by the electronic device. The at least one processor is configured to execute the one or more instructions to generate a contour mask of the object based on the feature map. The at least one processor is configured to execute the one or more instructions to generate a 3D point cloud of the object based on the contour mask and the depth information. The at least one processor is configured to execute the one or more instructions to generate a plurality of pose features of the object for representation in a 3D virtual space based on the contour mask and the 3D point cloud.

According to an embodiment of the disclosure, the at least one processor is configured to execute the one or more instructions to predict a plurality of keypoints indicating vertices of a 3D bounding volume of the object in the at least one RGB image frame based on the feature map. The at least one processor is configured to execute the one or more instructions to extract pixel regions corresponding to position of the object in the at least one RGB image frame based on the plurality of keypoints. The at least one processor is configured to execute the one or more instructions to generate the contour mask by masking features corresponding to the object in the feature map based on the pixel regions and the feature map.

According to an embodiment of the disclosure, the plurality of pose features generated by the at least one processor may include a set of pose features related to rotation, translation and size of the selected object.

According to an embodiment of the disclosure, the at least one processor is configured to execute the one or more instructions to obtain a sampled 3D point cloud of the object from the 3D point cloud. The at least one processor is configured to execute the one or more instructions to fuse the contour mask with the sampled 3D point cloud. The at least one processor is configured to execute the one or more instructions to generate the plurality of pose features based on the fusion of the contour mask with the sampled 3D point.

According to an embodiment of the disclosure, the at least one processor is configured to execute the one or more instructions to apply the at least one RGB image frame to a first AI model trained based on training RGB image frame to obtain the feature map. The first AI model may be trained based on a reconstruction loss calculated using a mesh representing the shape of the object included in the training RGB frame.

According to an embodiment of the disclosure, the at least one processor is configured to execute the one or more instructions to apply the contour mask and the 3D point cloud to a second AI model trained based on the point cloud of the training object to obtain the plurality of pose features of the object. The second AI model may be trained through a first training in which the second AI model is trained alone and a second training in which the first AI model and the second AI model are trained together.

According to an embodiment of the disclosure, the at least one processor is configured to execute the one or more instructions to obtain user input selecting one of a plurality of candidate objects included in the at least one RGB frame. The at least one processor is configured to execute the one or more instructions to determine the selected object from the plurality of candidate objects as the object.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

An embodiment disclosed herein may be implemented in the form of a recording medium including instructions executable by a computer, such as a program module executed by a computer. A Computer-readable medium may be any available medium that may be accessed by a computer and include both volatile and non-volatile media, removable and non-removable media. Also, computer-readable media may include computer storage media and communication media.

The computer storage media includes both volatile and non-volatile media and removable and non-removable media implemented by any method or technology for storing information, such as computer-readable instructions, data structures, program modules, or other types of data. Communication media may include computer readable instructions, data structures, or other types of data of modulated data signals, such as program modules. Also, computer-readable storage media may be provided in the form of non-transitory storage media. Here, “non-transitory storage media” is a tangible device and simply means not including signals (for example, electromagnetic waves), and the term does not distinguish between a case where data is semi-permanently stored in a storage medium and a case where data is temporarily stored in a storage medium. For example, “non-transitory storage media” may include a buffer where data is temporarily stored.

According to one embodiment, methods according to various embodiments disclosed in the disclosure may be included in a computer program product. The computer program product is commodity and may be traded between a seller and a buyer. The computer program product may be distributed in the form of a machine-readable storage medium (for example, a compact disc read only memory (CD-ROM)) or may be distributed (for example, downloaded or uploaded) directly or online through an application store or between two user devices (for example, smartphones). In the case of online distribution, at least a part of the computer program product (for example, a downloadable app) may be temporarily stored on a machine-readable storage medium, such as a server of an application store or a memory of a relay server or may be generated temporarily.

Advantages of the embodiment of the disclosure are illustrated herein.

The disclosure provides a method and apparatus for generating a virtual 3D object.

Prediction of pose features including 9-DoF (Degrees of Freedom) in the disclosure significantly enhances the user experience. This is particularly evident in applications such as overlaying a new texture 3D model of a keyboard onto an actual keyboard. Without the implementation of 9-DoF, the results could be unsatisfactory.

The electronic device provides a more scalable and flexible object detection and pose approach, and can handle a wide range of object categories without the need for separate models for each one.

The disclosure provides a method for creating more diverse and representative datasets. This will improve the accuracy and reliability of the pose, leading to better AR experiences.

The disclosure efficiently combines monocular and depth-based methods. This meets the stringent requirements of AR devices, ensuring high-quality AR overlays.

The electronic device, such as the AR device, can process any captured image from a real-world scene in real-time. It can overlay digital information (like 3D models, text, or animations) onto a user's view of the real-world scene. This provides an immersive and interactive AR experience In light of the technical advancements provided by the method illustrated according to one or more example embodiment, the features of the disclosure are not routine, conventional, or well-known aspects in the art, as the features of the disclosure provide the aforesaid solutions to the technical problems in the related art technologies. Further, the features of the disclosure provides a technical improvement of the functioning of the system itself, as the features of the disclosure provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

In an example case in which a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article, or a different number of devices/articles may be used instead of the shown number of devices or programs. According to another embodiment, the functionality and/or features of a device may be embodied by one or more other devices which are not explicitly described as having such functionality/features. Thus, an embodiment of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of generating pose information for a virtual three dimensional (3D) object by an electronic device, the method comprising:
obtaining, a feature map based on at least one RGB image frame captured by a camera of the electronic device;
obtaining depth information of an object in the at least one RGB image frame through at least one depth sensor associated with the electronic device;
generating, a contour mask of the object based on the feature map;
generating a 3D point cloud of the object based on the contour mask and the depth information;
generating a plurality of pose features of the object for representation in a 3D virtual space based on the contour mask and the 3D point cloud.

2. The method of claim 1, wherein the obtaining the contour mask comprises:
predicting a plurality of keypoints indicating vertices of a 3D bounding volume of the object in the at least one RGB image frame based on the feature map;
extracting pixel regions corresponding to position of the object in the at least one RGB image frame based on the plurality of keypoints; and
generating the contour mask by masking features corresponding to the object in the feature map based on the pixel regions and the feature map.

3. The method of claim 1, wherein the plurality of pose features comprises:
a set of pose features related to rotation, translation and size of the object.

4. The method of claim 1, wherein the generating the plurality of pose features comprises:
obtaining a sampled 3D point cloud of the object from the 3D point cloud;
fusing the contour mask with the sampled 3D point cloud; and
generating the plurality of pose features based on the fusion of the contour mask with the sampled 3D point cloud.

5. The method of claim 1, wherein the obtaining the feature map comprises:
applying the at least one RGB image frame to a first artificial intelligence (AI) model trained based on a training RGB image frame to obtain the feature map;
wherein the first AI model is trained based on a reconstruction loss calculated using a mesh representing the shape of an object included in the training RGB image frame.

6. The method of claim 5, wherein the generating the plurality of pose features of the object comprises:
applying the contour mask and the 3D point cloud to a second AI model trained based on training 3D point clouds to obtain the plurality of pose features of the object;
wherein the second AI model is trained through a first training in which the second AI model is trained alone and a second training in which the first AI model and the second AI model are trained together.

7. The method of claim 1, further comprising:
obtaining user input selecting one of a plurality of candidate objects included in the at least one RGB image frame as the object.

8. The method as claimed in claim 1 further comprises:
switching to one of a first prediction mode or a second prediction mode based on one or more predefined conditions,
wherein the first prediction mode comprises prediction of a first set of pose features relate to rotation and translation of the object, and the second prediction mode comprises prediction of a second set of pose features relate to rotation, translation and size of the object.

9. The method of claim 1, further comprising:
generating a virtual 3D object based on application of a texture corresponding to the object and the predicted plurality of pose features on to the 3D point cloud of the object.

10. The method of claimed claim 2, wherein the feature representation is extracted using a first trained AI model related to a Path Aggregation Network (PAN), and the pixel regions are extracted using a second trained AI model related to a Transformer Attention Network (TAN).

11. An electronic device comprising:
a camera;
at least one depth sensor;
a memory storing one or more instruction; and
at least one processor configured to execute the one or more instructions stored in the memory;
wherein the one or more instructions, when executed by the at least one processor, is configured to cause the electronic device to:
obtain a feature map based on at least one RGB image frame captured by the camera;
obtain depth information of an object in the at least one RGB image frame through the at least one depth sensor;
generate a contour mask of the object based on the feature map;
generate a three dimensional (3D) point cloud of the object based on the contour mask and the depth information; and
generate a plurality of pose features of the object for representation in a 3D virtual space based on the contour mask and the 3D point cloud.

12. The electronic device of claim 11, wherein, the one or more instructions, when executed by the at least one processor, is further configured to cause the electronic device to:
predict a plurality of keypoints indicating vertices of a 3D bounding volume of the object in the at least one RGB image frame based on the feature map;
extract pixel regions corresponding to position of the object in the at least one RGB image frame based on the plurality of keypoints; and
generate the contour mask by masking features corresponding to the object in the feature map based on the pixel regions and the feature map.

13. The electronic device of claim 11, wherein the plurality of pose features comprises: a set of pose features related to rotation, translation and size of the selected object.

14. The electronic device of claim 11, wherein, the one or more instructions, when executed by the at least one processor, is further configured to cause the electronic device to:
obtain a sampled 3D point cloud of the object from the 3D point cloud;
fuse the contour mask with the sampled 3D point cloud; and
generate the plurality of pose features based on the fusion of the contour mask with the sampled 3D point cloud.

15. The electronic device of claim 11, wherein, the one or more instructions, when executed by the at least one processor, is further configured to cause the electronic device to:
apply the at least one RGB image frame to a first artificial intelligence (AI) model trained based on training RGB image frame to obtain the feature map;
wherein the first AI model is trained based on a reconstruction loss calculated using a mesh representing the shape of an object included in the training RGB image frame.

16. The electronic device of claim 15, wherein, the one or more instructions, when executed by the at least one processor, is further configured to cause the electronic device to:
apply the contour mask and the 3D point cloud to a second AI model trained based on training 3D point clouds to obtain the plurality of pose features of the object;
wherein the second AI model is trained through a first training in which the second AI model is trained alone and a second training in which the first AI model and the second AI model are trained together.

17. The electronic device of claim 11, wherein, the one or more instructions, when executed by the at least one processor, is further configured to cause the electronic device to:
obtain user input selecting one of a plurality of candidate objects included in the at least one RGB image frame as the object.

18. The electronic device of claim 11, wherein, the one or more instructions, when executed by the at least one processor, is further configured to cause the electronic device to:
switch to one of a first prediction mode or a second prediction mode based on one or more predefined conditions,
wherein the first prediction mode comprises prediction of a first set of pose features relate to rotation and translation of the object, and the second prediction mode comprises prediction of a second set of pose features relate to rotation, translation and size of the object.

19. The electronic device of claim 11, wherein, the one or more instructions, when executed by the at least one processor, is further configured to cause the electronic device to:
generate a virtual 3D object based on application of a texture corresponding to the object and the predicted plurality of pose features on to the 3D point cloud of the object.

20. A computer-readable recording medium having recorded thereon a program for performing a control method on a computer, the control method comprising:
obtaining, a feature map based on at least one RGB image frame captured by a camera of an electronic device;
obtaining depth information of an object in the at least one RGB image frame through at least one depth sensor associated with the electronic device;
generating, a contour mask of the object based on the feature map;
generating a 3D point cloud of the object based on the contour mask and the depth information;
generating a plurality of pose features of the object for representation in a 3D virtual space based on the contour mask and the 3D point cloud.
